(19) United States
(12) Patent Application Publication
(10) Pub. No.: US 2020/0070719 A1
(43) Pub. Date: Mar. 5, 2020

(54) Acoustic Vehicle Warning System for a Motor Vehicle Having an Integrated Function for Outputting Acoustic Warning Signals

(71) Applicant: AUDI AG, Ingolstadt (DE)

(72) Inventor: Sebastian WERNER, Rohrbach (DE)

(73) Assignee: AUDI AG, Ingolstadt (DE)

(21) Appl. No.: 16/493,164

(22) PCT Filed: Mar. 15, 2018
(86) PCT No.: PCT/EP2018/056472

§ 371 Date: Sep. 11, 2019

(30) Foreign Application Priority Data
Mar. 15, 2017 (DE) 10 2017 204 332.6

(51) Int. Cl. B60Q 5/00; H04R 3/12

(52) U.S. Cl. CPC B60Q 5/008; H04R 2499/13; H04R 3/12; B60Q 5/006

(57) ABSTRACT

The present disclosure relates to an acoustic vehicle warning system for a motor vehicle, comprising a control unit and at least one loudspeaker, the control unit being designed to output a continuous acoustic signal by means of the at least one loudspeaker during driving operation of the motor vehicle. The control unit is designed to actuate the at least one loudspeaker by means of an actuation signal after an actuation unit has been actuated, the loudspeaker being designed to output an acoustic warning signal after the actuation signal has been received.

### TECHNICAL FIELD

The present disclosure relates to an acoustic vehicle warning system having an integrated function for outputting acoustic warning signals.

### BACKGROUND

For safety reasons, it is provided for, or required by law in some countries, that an electrically-operated motor vehicle or a hybrid motor vehicle comprise an acoustic vehicle warning system (Acoustic Vehicle Alerting System, abbreviated AVAS). The acoustic vehicle warning system is a device which is configured to output continuous acoustic signals to the surroundings of the motor vehicle, thereby alerting the surroundings to the motor vehicle. An AVAS vehicle warning system is described, for example, in document ECE/TRANS/WP.29/2016/26 of the United Nations Economic Commission for Europe. The output of the continuous acoustic signals is non-stop, in particular without the intervention of a driver, and is intended to compensate for the absence of engine noise. This allows other road users to acoustically perceive an electrically-powered motor vehicle. It may be that continuous acoustic signals are modeled on combustion engine noise.

It is also required that road vehicles should comprise an acoustic warning signal device that can be activated by the driver and/or an autopilot when needed. These may be horns, for example. The acoustic warning signals output by this device are used to make vulnerable road users aware of the approach of a motor vehicle. The output of an acoustic warning signal is usually carried out by the actuation of a device on the steering wheel of the motor vehicle by the driver. As a rule, this device is realized as an impact horn, or as an electromagnetic trumpet horn, which is located on the vehicle front. Due to the mounting of this device in the region of the inflow surfaces of the cooling air, it may have a negative effect on cooling performance.

Because of this problem, it is advantageous to integrate the possibility of outputting an acoustic warning signal in another device, thereby making it possible to dispense with a separate device for outputting acoustic warning signals.

Such a device is described in DE 103 27 322 A1. The described system is an active noise attenuation system for use in motor vehicles which is configured to emit a horn tone in response to the actuation of a horn switch. In this case, the system may be configured such that the active noise attenuation is temporarily interrupted in response to acutation of the horn switch.

A disadvantage of the use of a noise attenuation system for the output of acoustic warning signals may be the fact that said system can be mounted at a location of the motor vehicle which allows a damping of the vehicle noise for an interior, but is not suitable for an output of sounds into the surroundings.

DE 209 90 11 360 U1 describes a special signal system and a camouflaged emergency vehicle having such a special signal system which is configured to generate a normal horn acoustic signal.

Although a special signal system is usually installed in a motor vehicle in such a manner that it allows an efficient output of sounds to the surroundings of the motor vehicle, only emergency vehicles comprise a special signal system. Due to this fact, this solution is not applicable in general.

### BRIEF DESCRIPTION OF THE DRAWINGS/FIGURES

FIG. 1 shows a motor vehicle having an AVAS vehicle warning system, in accordance with some embodiments.

### DETAILED DESCRIPTION

The object of the present disclosure is to reduce the number of components required for generating noises in a motor vehicle.

The object is achieved by the subjects of the independent claims. Advantageous developments of various embodiments are disclosed by the features of the dependent claims, the following description, and the drawing.

In some embodiments, an AVAS vehicle warning system for a motor vehicle is disclosed. Said AVAS vehicle warning system comprises a control unit and at least one loudspeaker which is configured for the output of continuous acoustic signals. The control unit is configured, at least after an actuation of an actuation unit, to control the at least one loudspeaker via an actuation signal. The at least one loudspeaker is configured to output an acoustic warning signal upon receipt of the actuation signal. By way of non-limiting example, the actuation of the actuation unit results in the output of an acoustic warning signal by means of the at least one loudspeaker of the AVAS vehicle warning system.

In some embodiments, the AVAS vehicle warning system is a noise-generating device which is configured to output a continuous acoustic signal during driving operation of the motor vehicle in order thus to alert road users to the presence of the motor vehicle in the manner as described herein. The output of the at least one continuous acoustic signal is done without intervention of the driver. The at least one continuous acoustic signal is intended to replace the lack of internal combustion engine noise in electrically-powered motor vehicles and hybrid vehicles in the electric drive mode, whereby the motor vehicle can be perceived acoustically by other road users. The generation of the noise can be effected by at least one loudspeaker, which may be mounted in the region of the engine. Loudspeakers can be designed so that they can reproduce frequencies which can reproduce the frequency spectrum mainly generated by engines.

In some embodiments, the control unit can be a microprocessor or a microcontroller, which is connected to the loudspeaker and can control the loudspeaker via a signal which causes a sound to be output by the loudspeaker which depends on the type of signal. The control unit may be configured to control the loudspeaker by means of an actuation signal for outputting an acoustic warning signal after an actuation of the actuation unit. The control unit may be configured to control the loudspeaker via a signal for outputting the continuous acoustic signal. The control unit may be configured to adapt the nature of the continuous acoustic signal to an operating state of the motor vehicle. For example, this may be dependent on a current operating point of the motor vehicle.

By way of non-limiting example, an acoustic warning signal is in particular an acoustic signal which is output over a predefinable period of time with constant fundamental frequencies, and which is free from background noise. The period depends on the actuation time of the actuation unit. The acoustic warning signal serves the purpose of warning other road users.

In some embodiments, the actuation unit is a device which can be mounted within reach of the motor vehicle driver. This device may for example be mounted on the steering wheel of the motor vehicle and connected to the control unit. If the motor vehicle driver actuates the actuation unit, this is detected by the control unit.

Accordingly, acoustic warning signals can be reproduced via the acoustic vehicle warning system. This results in the advantage that no device has to be installed in the motor vehicle which has the single purpose of reproducing an acoustic warning signal. As a result of the use of an existing device, savings can therefore be made on components, costs, space and wiring.

In some embodiments, the control unit is configured to interrupt the output of a continuous acoustic signal for the period of output of an acoustic warning signal. By way of non-limiting example, when an acoustic warning signal is output, only this acoustic signal is reproduced by the loudspeaker. The output of a continuous acoustic signal by the loudspeaker is thus deactivated for the period during which an acoustic warning signal is output. This results in the advantage that the acoustic warning signal is not superimposed by the continuous acoustic signal, and thus can be perceived more clearly. In addition, this approach allows compliance with regulations prohibiting the reproduction of background noise during playback of an acoustic warning signal.

In some embodiments, the loudspeaker is located behind a front apron of the motor vehicle and is configured to output a main emission direction in the forward direction of the motor vehicle. By way of non-limiting example, the loudspeaker is configured so that the acoustic warning signal is reproduced in the forward direction of travel. This has the advantage that the acoustic warning signal is output in the direction of the usual recipients of the acoustic warning signal. Thus, the spatial sound output of the AVAS vehicle warning system does not differ from a conventional device for outputting acoustic warning signals. The main emission direction is the direction of the loudest acoustic output. The main emission direction is measured in particular at a distance of at least 1 meter from the motor vehicle, so that the influence of reflections on the front apron and/or on the driving surface is also taken into account. For example, a loudspeaker can be oriented downwards onto the driving surface and be deflected there by reflection of the airborne sound emitted by the loudspeaker into the main emission direction.

In some embodiments, the at least one loudspeaker is configured to reproduce the acoustic warning signal in a frequency range of 400-600 Hz with a sound pressure level of at least 60 dB A (in particular more than 70 dB A), measured at a 1 meter distance. Known acoustic warning signals have frequencies which are in the range between 400-600 Hz. By way of non-limiting example, the at least one loudspeaker is configured to reproduce the frequency spectrum of a known acoustic warning signal. This results in the advantage that the acoustic warning signal can also be identified as such by road users.

In some embodiments, a motor vehicle comprising an AVAS vehicle warning system is disclosed.

The motor vehicle has features such as those previously described for the device according to the embodiments as described herein. For this reason, the corresponding embodiments of the motor vehicle are not described again.

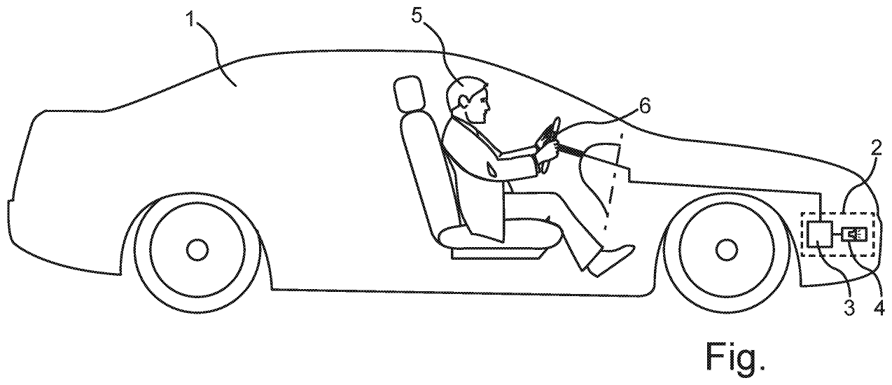

Embodiments as described herein are described below with reference FIG. 1 that shows a motor vehicle having an AVAS vehicle warning system, in accordance with some embodiments.

The embodiment described below is a preferred embodiment that constitutes individual features that are to be considered independently of one another or in a combination other than that described herein. In addition, features additional to those already described herein can also be added to the described embodiment.

Elements having the same function have been provided with the same reference numerals in the drawing.

FIG. 1 shows a motor vehicle having an AVAS vehicle warning system, in accordance with some embodiments. FIG. 1 shows a motor vehicle 1 which comprises an AVAS vehicle warning system 2. The AVAS vehicle warning system 2 may comprise a control unit 3 and a loudspeaker 4. The control unit 3 can be connected to the at least one loudspeaker 4 in such a way that it can be controlled by signals of the control unit 3. The control unit 3 can be realized, for example, as a microprocessor or microcontroller. The at least one loudspeaker 4 may output sounds in response to a transmitted signal. The nature of the sounds, which may comprise, for example, the frequencies, the volume and the duration of playback, may be defined by the content of the signals. The at least one loudspeaker 4 may be an electrodynamic loudspeaker with an integrated amplifier. This may be configured to also reproduce frequencies in the range between 400-600 Hz with a sound pressure level of at least 60 dB A (in particular more than 70 dB A), measured at a distance of 1 meter. For example, to allow a driver 5 of the motor vehicle 1 to enable the output of an acoustic warning signal by the AVAS vehicle warning system 2, the steering wheel may comprise an actuation unit 6. An actuation of the actuation unit 6 can be detected by the control unit 3 of the acoustic vehicle warning system 2. The control unit 3 can be configured in such a way that, after the detection, it transmits an actuation signal to the loudspeaker 4, which causes the output of an acoustic warning signal. It may be that at the time of actuation of the actuation unit 6, a continuous acoustic signal is reproduced by the AVAS vehicle warning system 2. The playback of the continuous acoustic signal can be interrupted by the control unit 3 for the playback period of the acoustic warning signal, so that only the acoustic warning signal is reproduced. The loudspeaker 4 may be located under or behind a front apron of the motor vehicle 1 and may be configured such that it can output the acoustic warning signal in the forward direction of the motor vehicle.

Overall, the examples show how the present disclosure reduces the number of components for generating sounds in a motor vehicle.

1.-5. (canceled)

6. A motor vehicle comprising:
an acoustic vehicle warning system comprising:
a control unit;
an actuation unit; and
at least one loudspeaker,
wherein the control unit is configured to perform operations comprising:
actuating the actuation unit to generate an actuation signal,
actuating the at least one loudspeaker using the actuation signal,
outputting a continuous acoustic signal using the at least one loudspeaker during driving operation of the motor vehicle, and
interrupting the output of the continuous acoustic signal for outputting an acoustic warning signal for a period during which the acoustic warning signal is output, and
wherein the at least one loudspeaker is configured to output the acoustic warning signal upon receipt of the actuation signal.

7. The motor vehicle of claim 6, wherein the acoustic warning signal is in a frequency range of 400-600 Hz with a sound pressure level of at least 60 dB A measured at a distance of 1 meter.

8. The motor vehicle of claim 6, wherein the at least one loudspeaker is located under a front apron of the motor vehicle and oriented downwards onto a driving surface for reflecting the acoustic warning signal from the driving surface in a main emission direction that corresponds with a forward direction of the motor vehicle.

9. The motor vehicle of claim 6, wherein the motor vehicle is an electrically-powered motor vehicle or an hybrid motor vehicle in an electric drive mode.

10. The motor vehicle of claim 6, wherein the actuation unit is mounted within reach of a motor vehicle driver.

11. A method, comprising:
generating, at a control unit of an acoustic vehicle warning system, an actuation signal to actuate at least one loudspeaker, wherein the acoustic vehicle warning system is internal to a motor vehicle;
outputting a continuous acoustic signal using the at least one loudspeaker during driving operation of the motor vehicle; and
interrupting the continuous acoustic signal for outputting an acoustic warning signal for a period during which the account warning signal is output,
wherein the at least one loudspeaker is configured to output the acoustic warning signal upon receipt of the actuation signal.

12. The method of claim 11, wherein the acoustic warning signal is in a frequency range of 400-600 Hz with a sound pressure level of at least 60 dB A measured at a distance of 1 meter.

13. The method of claim 11, wherein the at least one loudspeaker is located under a front apron of the motor vehicle and oriented downwards onto a driving surface for reflecting the acoustic warning signal from the driving surface in a main emission direction that corresponds with a forward direction of the motor vehicle.

14. The method of claim 11, wherein the motor vehicle is an electrically-powered motor vehicle or an hybrid motor vehicle in an electric drive mode.

15. The method of claim 11, wherein the actuation unit is mounted within reach of a motor vehicle driver.
